(19) United States
(12) Patent Application Publication
(10) Pub. No.: US 2024/0330065 A1
(43) Pub. Date: Oct. 3, 2024

(54) EDGE DATA PROCESSING

(71) Applicant: INTERNATIONAL BUSINESS MACHINES CORPORATION, ARMONK, NY (US)

(72) Inventors: Charan ACHARYA CHANDRASHEKAR, Bangalore (IN); Sudhakar T. SESHAGIRI, Bangalore (IN); Shwetha GOPALAKRISHNA, Bangalore (IN); Prasanna Alur MATHADA, Bangalore (IN)

(21) Appl. No.: 18/192,230

(22) Filed: Mar. 29, 2023

(51) Int. Cl. G06F 9/50; B64U 10/00; H04B 7/185; H04L 67/12

(52) U.S. Cl. CPC G06F 9/505; B64U 10/00; H04B 7/18502; H04L 67/12; B64U 2101/20

(57) ABSTRACT

Methods, computer program products, and systems are presented. The method computer program products, and systems can include, for instance: examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments; and scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments.

### BACKGROUND

Embodiments herein relate generally to edge data processing and particularly to use of mobile computing for edge data processing.

A network service can include a software application running at the network software application layer and above that provides data storage, manipulation, presentation, communication or other capability which is often implemented using a client-server architecture based on software application layer network protocols. Each network service is usually provided by a server component running on one or more computer and accessed via a network by client components running on other devices. However, client and server components may both run on the same machine. In addition, a dedicated server computer may offer multiple network services concurrently.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments: scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments; and deploying the mobile multi-access computing unmanned aerial vehicle for performance of the data upload and processing session.

In another aspect, a computer program product can be provided. The computer program product can include a computer readable storage medium readable by one or more processing circuit and storing instructions for execution by one or more processor for performing a method. The method can include, for example: examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments: scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments; and deploying the mobile multi-access computing unmanned aerial vehicle for performance of the data upload and processing session.

In a further aspect, a system can be provided. The system can include, for example a memory. In addition, the system can include one or more processor in communication with the memory. Further, the system can include program instructions executable by the one or more processor via the memory to perform a method. The method can include, for example: examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments; scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments; and deploying the mobile multi-access computing unmanned aerial vehicle for performance of the data upload and processing session.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having an orchestrator, a plurality of IoT edge computer environments, and a plurality of mobile MEC UAVs according to one embodiment;

FIG. 2 depicts an infrastructure view of the system of FIG. 1 according to one embodiment:

FIG. 3 is a flowchart illustrating a method for performance by mobile MEC UAVs in communication with IoT edge computer environments and an orchestrator according to one embodiment:

FIG. 4 depicts a predictive model that can be trained with use of training data according to one embodiment:

FIG. 5 is a diagram depicting clustering analysis that can be utilized by an orchestrator for performance of according to one embodiment:

FIG. 6 is a schematic view of the system of FIG. 1 according to one embodiment:

FIG. 7 is a schematic view of the system of FIG. 1 according to one embodiment:

FIG. 8 is a flowchart illustrating a method for performance by an orchestrator according to one embodiment:

FIG. 9 depicts a computing environment according to one embodiment.

### DETAILED DESCRIPTION

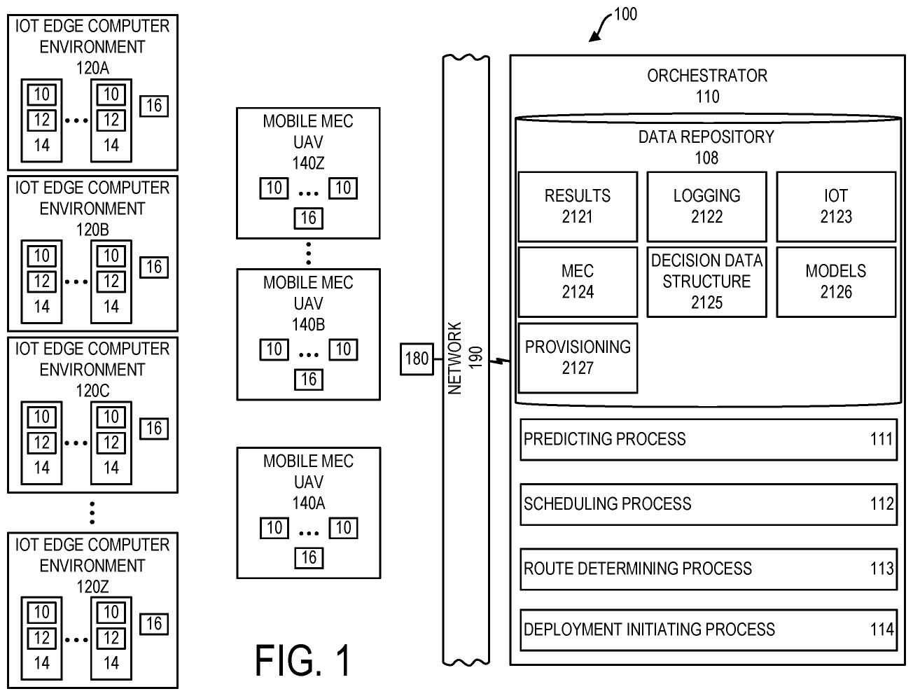

System 100 for use in processing edge device data is shown in FIG. 1. System 100 can include orchestrator 110 having data repository 108. Orchestrator 110, which can be a computing node-based orchestrator, can be configured to obtain data generated at spaced apart IoT edge computer environments 120A-120Z, wherein Z refers to any integer. Respective Internet of Things (IoT) edge computer environments 120A-120Z can include one or more IoT device 14. In respect to IoT edge computer environments 120A-120Z, “Z” can refer to an integer of any positive value.

Respective IoT devices 14 can include, e.g., a combination of a computing node 10 and an Internet of Things (IoT) sensor 12. Respective ones of the IoT edge computer environments 120A-120Z can be spaced apart from one another, e.g., each can be spaced at a distance of at least one kilometer (km) away from one another in one example. The one or more IoT devices 14 of the individual IT edge computer environments 120A-120Z can be closely spaced, e.g., disposed within a 10 meter by 10 meter area. Embodiments herein recognize that computing nodes 10 of IoT devices 14 can be minimally provisioned, with minimal functionality to support minimal if any data processing, data storage, and I/O functionality. In remote areas, it can be common to power IoT devices with solar rechargeable batteries that can provide minimal power output. In one aspect there can be first to Nth IoT edge computer environments defining IoT edge computer environments 120A-120Z, wherein “N” refers to any integer. The first to Nth IoT edge computer environments can define a set of IoT edge computer environments. Further, respective ones of the IoT edge computer environments can have respective associated IoT edge computer environment locations.

Orchestrator 110 can obtain data generated by IoT edge computer environments 120A-120Z with use of mobile multi-access edge computing (MEC) unmanned aerial vehicles (UAVs) 140A-140Z, wherein “Z” can refer to an integer of any positive value. Each respective mobile MEC UAV of mobile MEC UAVs 140A to 140Z can include one or more computing node 10. Each mobile MEC UAV 140A-140Z can be capable of, and can be configured to be, flown between various locations, such as a base location in connection range of orchestrator 110 and between respective locations associated to respective ones of IoT edge computer environments 120A-120Z. When a respective mobile MEC UAV is in connection range of orchestrator 110, the mobile MEC UAV of mobile MEC UAVs 140A-140Z can communicate with orchestrator 110. When a mobile MEC UAV of mobile MEC UAVs 140A-140Z is in connection range of the respective IoT edge computer environments 120A-120Z, the mobile MEC UAV can communicate with the respective IoT edge computer environment via wireless transceivers 16 of the mobile MEC UAV and the IoT edge computer environment. In one aspect there can be first to Nth IoT edge computer environments defining IoT edge computer environments 120A-120Z, wherein “N” refers to any integer. The first to Nth IoT edge computer environments can define a set of IoT edge computer environments. Further, respective ones of the IoT edge computer environments can have respective associated IoT edge computer environment locations. When a certain mobile MEC UAV is at a particular IoT edge computer location associated to a particular IoT edge computer environment, the certain mobile MEC UAV can be in connection range with the particular IT edge computer environment.

Mobile MEC UAVs 140A-140Z can communicate with orchestrator 110 via network 190. Network 190 can include a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. Network 190 can include base station 180 to which wireless transceivers 16 of mobile MEC UAVs connect when in connection range.

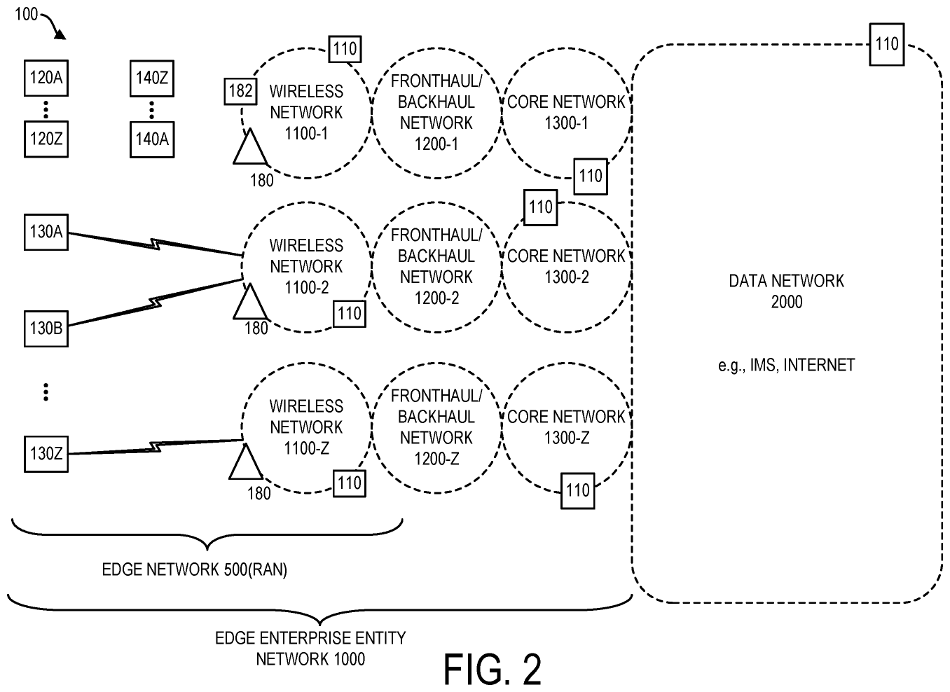

FIG. 2 depicts a physical network implementation view of system 100. System 100 can include IoT edge computer environments 120A-120Z and IoT edge computer environments 130A-130Z in communication with data network 2000 via a plurality of edge enterprise entity networks 1000. System 100, as set forth herein, including in reference to FIG. 1A and FIG. 2, can be compliant with Fifth Generation (5G) technologies, including the New Radio (NR) standard, documents of 3GPP TS 28.530 V15.1.0 Release 15 by the 3rd Generation Partnership Project (3GPP), and the technical reports of Release 16 of the 3GPP (3GPP Release 16 reports). Respective edge enterprise entity networks 1000 can include edge infrastructure owned, operated, and/or controlled by one or more edge enterprise entity distributed throughout different geospatial regions within a geospatial area. In one embodiment, a certain edge enterprise entity can own, operate, and/or control the edge network infrastructure comprising wireless network 1100-1, fronthaul/backhaul network 1200-1, and core network 1300-1 in a first geospatial region. The certain edge enterprise can own, operate, and/or control the edge infrastructure comprising wireless network 1100-2, fronthaul/backhaul network 1200-2, and core network 1300-2 on a second geospatial region. The certain edge enterprise entity can own, operate, and/or control the edge infrastructure comprising wireless network 1100-Z, fronthaul/backhaul network 1200-Z, and core network 1300-Z in a third geospatial region. In another example, the different edge enterprise entity networks 1000 can be owned, operated, or controlled by different edge enterprise entities. Different respective ones of the edge enterprise entities can be telecommunications network providers which are sometimes referred to as communication service providers (edge enterprise entity CSPs).

In the described embodiment of FIG. 2, the combination of a wireless network and a fronthaul network can define edge network 500 including a radio access network (RAN). Edge network 500 can define edge infrastructure. The depicted RANs provide access from IoT edge computer environments 120A-120Z, and 130A-130Z to respective core networks. In an alternative embodiment, one or more of edge networks 500 can be provided by a content delivery network (CDN).

Each of the different IoT edge computer environments 120A-120Z, 130A-130Z can be associated to a different user, e.g., a customer end user or an enterprise agent user. An IoT device of IoT edge computer environments 120A-120Z, 130A-130Z can be provided by, e.g., a computing node 10 in combination with an IoT sensor 12 (FIG. 1). The IoT sensor can be co-located with or be external to computing node 10.

Embodiments herein recognize that hosting service functions on one or more computing node within an edge enterprise entity network 1000 can provide various advantages including latency advantages for speed of service delivery to IoT edge computer environments 120A-120Z, 130A-130Z. Edge enterprise entity hosted service functions can be hosted, e.g., within edge network 500 or otherwise within edge enterprise entity network 1000.

Data network 2000 can include, e.g., an IP multimedia sub-system (IMS) and/or “the internet” which can be regarded as the network of networks that consist of private, public, academic, business, and government networks of local to global scope linked by a broad array of electronic, wireless, and optical networking technologies. Data network 2000 can include, e.g., a plurality of non-edge data centers. Such data centers can include private enterprise data centers as well as multi-tenancy data centers provided by IT enterprises that provide for hosting of service functions developed by a plurality of different enterprise entities.

Orchestrator 110, in one embodiment, can be disposed in data network 2000. In one embodiment, orchestrator 110 can be iteratively replicated from data network 2000 into respective ones of core network 1300-1, 1300-2, and 1300-Z. As shown in FIG. 1B, the different computer environments of IoT edge computer environments 120A-120Z, 130A-130Z can be disposed in geospatially differentiated regions over an area. In one example, the different geospatial regions can be spaced apart in different geospatial regions. The different geospatial regions defined by a footprint of a respective computer environment can be in different e.g., counties, cities, states, and/or different countries. The different computer environments of IoT edge computer environments 120A-120Z, 130A-130Z can each respectively be disposed in a different edge network 500, and particularly each respective IoT edge computer environment 120A-120Z, 130A-130Z can be disposed in a different wireless network associated to a particular edge network. The different geospatial regions associated to the respective IoT edge computer environment 120A-120Z, 130A-130Z can include geospatial regions that are spaced apart and located, e.g., about 1 K apart or more, or about 10 K apart or more. By being disposed within an edge network 500, a computer environment can be regarded as an edge computer environment.

Referring to FIG. 2, IoT edge computer environments 130A-130B can be in connection range of one or more base station 180 associated to a wireless network. However, IoT edge computer environments 120A-120Z can be out of connection range from any base station 180. Accordingly, embodiments herein recognize that IoT edge computer environments 120A-120Z can benefit from services provided from mobile MEC UAVs 140A-140Z which can be configured to be autonomously flyable between base station 180 of wireless network 1100-1 and respective ones of IoT edge computer environments 120A-120Z.

As shown in FIG. 2, wireless network 1100-1 having base station 180 which can provide connection to orchestrator 110 can also include an associated recharging station 182 at a base location in connection range to base station 180 and to orchestrator 110. Recharging station 182 can be configured to provide wireline or wireless recharging of mobile MEC UAVs that travel to a connection range of base station 180 of wireless network 1100-1. Thus, mobile MEC UAVs that travel to a connection range of base station 180 of wireless network 1100-1 can be fully recharged to full battery capacity at recharging station 182.

Embodiments herein recognize that in “the last mile,” there can be various IoT devices out of connection range of any network infrastructure base station. To provide connectivity in such situations, system 100 can be configured so that mobile MEC UAVs 140A-140Z can fly to the location of an IoT edge computer environment for data uploading and processing and then fly to a base location in connection range of orchestrator 110 for performance of data uploading to orchestrator 110.

Embodiments herein, among other advantages, address a problem with the “last mile” of computer system connectivity, and can intelligently provide with conserved resources connectivity to remote areas out of connectivity range to centralized system.

Data repository 108 of orchestrator 110 can store various data. Data repository 108 in results area 2121 can store results data. Data repository 108 in results area 2121 can store results data obtained from respective ones of IoT edge computer environments 120A-120Z. The results data can include, e.g., structured data resulting from processing of uploaded IoT sensor data by a mobile MEC UAV.

Data repository 108 in logging area 2122 can store logging data obtained from mobile MEC UAVs 140A-140Z. Logging data can include, e.g., computing resource consumption data. The computing resource consumption data can be obtained. e.g., from a logging agent of a mobile MEC UAV during obtaining and processing of IoT sensor data from an IoT edge computer environment. The computing resource consumption data can include CPU consumption data, memory consumption data, (e.g., working memory or storage memory) and network consumption data of a mobile MEC UAV as it processes IoT sensor data uploaded from an IoT edge computer environment. CPU consumption data can include, e.g., CPU user time (e.g., in ms and or number of cycles), CPU system time, CPU interrupt time, and CPU wait time. Memory consumption data can include, e.g., number of working memory I/O operations, number of storage memory I/O operations, working memory storage space utilized, and storage memory storage space utilized.

Network consumption data can include, e.g., throughput parameter values expressed, e.g., in terms of bits per second (BPS), response time parameter values, latency parameter values, and packet loss (error rate) parameter values. When a mobile MEC UAV is connected to a particular IoT edge computer environment, a data uploading and processing session can be established. Logging area 2122 records computing resource consumption logging data for each data uploading and processing session performed by system 100. For each session, orchestrator 110 can record, with an associated to the obtained logging data, a session ID, a timestamp for the session, an identifier of the IoT edge computer environment of the session, and an identifier of the mobile MEC UAV of the session. Logging data produced by mobile MEC UAVs 140A-140Z stored in logging area 2122 can include data other than computing resource consumption data and in one embodiment can include environmental sensor data. In one embodiment, a mobile MEC UAV can include an on-board camera and can be active to obtain camera images of IoT edge computer environments that are visited. Camera images by orchestrator 110 and or respective mobile MEC UAV's can be subject to camera image processing for pattern recognition and identified pattern sets associated to an IoT edge computer environment can be expressed as parameter values. In one embodiment, a mobile MEC UAV can include another type of environment sensor, e.g., a temperature sensor, humidity sensor, and/or acoustic sensor, and can be active to temperature, humidity, and/or sound data of IoT edge computer environments that are visited. Regarding processing of camera image data, orchestrator 110 can run an image recognition process to examine spatial image data representing a feature of interest. Orchestrator 110 running an image recognition process can include orchestrator 110 employing pattern recognition processing using one or more of e.g., feature extraction algorithms, classification algorithms, and/or clustering algorithms. In one embodiment, orchestrator 110 running an image recognition process can include performing of digital image processing. Digital image processing can include, e.g., filtering, edge detection, shape classification, optical character recognition (OCR), and/or encoded information decoding.

Data repository 108 in IoT area 2123 can include data on IoT edge computer environments 120A-120Z serviced by system 100 and by orchestrator 110. IoT data can include, e.g., data specifying the hardware provisioning of each respective IoT edge computer environment, the data types provided by each respective IoT edge computer environment, security requirements of each respective IoT edge computer environment, coordinate data specifying the geospatial location of each respective IoT edge computer environment. In IoT area 2123, orchestrator 110 can establish a universal unique identifier (UUID) for each IoT edge computer environment of IoT edge computer environments 120A to 120Z and for each IoT device 14 therein. In one simplified embodiment, each IoT edge computer environment can include one IoT device.

Data repository 108 in MEC area 2124 can store data on each respective mobile MEC UAV 140A-140Z of system 100. MEC area 2124 can store data specifying, e.g., the hardware provisioning of each mobile MEC UAV, e.g., the number of computing nodes, etc., computing resource capabilities of each mobile MEC UAV, security capabilities of each mobile MEC UAV, current predicted battery life of each mobile MEC UAV, and hardware provisioning data of each mobile MEC UAV. MEC area 2124 can include UAV specific provisioning, e.g., the weight, design configuration, drone model type, etc. for the mobile MEC UAV. Orchestrator 110 for each mobile MEC UAV specified in MEC area 2124 can assign a universal unique identifier (UUID).

Orchestrator 110, in decision data structure area 2125, can store decision data structures that facilitate orchestrator 110 returning action decisions.

Orchestrator 110, in models area 2126 can store predictive models. Predictive models stored in models area 2126 can be trained and configured with use of training data. Once trained, predictive models can be configured to return and provide predictions being queried with query data.

Orchestrator 110 in provisioning area 2127 of data repository 108 can store data processing applications per performance of certain data processing with respect to each respective IoT edge computer environment of IoT edge computer environments 120A to 120Z.

Orchestrator 110 can run various processes. Orchestrator 110 running predicting process 111 can predict the computing resource consumption IoT edge computer environment. For each data processing session involving an IoT edge computer environment, system 100 can record logging data in logging area 2122. Orchestrator 110 running predicting process 111 can include orchestrator 110 updating predicted computing resource consumption of an IoT edge computer environment after each session producing logging data that has been uploaded into logging area 2122.

Orchestrator 110 running predicting process 111 can include orchestrator 110 querying one or more predictive model trained with training data to provide predictions as to computing resource consumption of an IoT edge computer environment. The described one or more predictive model can be trained with iterations of training data provided by the described logging data recorded in logging area 2122.

Orchestrator 110 running scheduling process 112 can schedule a mobile MEC UAV 140Z to initiate an uploading and processing session in which IoT sensor data from an IoT edge computer environment is uploaded to a mobile MEC UAC for processing.

Orchestrator 110 performing scheduling process 112 can include orchestrator 110 applying one or more criterion, and orchestrator 110 performing scheduling in response to the one or more criterion being satisfied. The one or more criterion can include, e.g., a computing resource matching criterion, a range matching criterion, a prioritization matching criterion, and a function matching criterion. Orchestrator 110 applying a computing resource matching criterion can include orchestrator 110 using a result of orchestrator 110 running prediction process 111. Orchestrator 110 applying a range matching criterion can use both data specifying a distance of a mobile MEC UAV to an IoT edge computer environment along a candidate route and remaining battery life of the mobile MEC UAV. Orchestrator 110 applying a prioritization matching criterion can examine a prioritization level assigned to an IoT edge computer environment. Orchestrator 110 applying a function matching criterion can include orchestrator examining a required function assigned to the IoT edge computer environment. A function match criterion, in one example, can include security feature matching between an IoT edge computer environment and a mobile MEC UAV.

Orchestrator 110 running scheduling process 112 can include orchestrator 110 performing a filtering process to filter out mobile MEC UAVs for possible selection as a mobile MEC UAV for initiating an IoT data uploading and processing session. In one use case example, orchestrator 110 running scheduling process 112 can include orchestrator 110 applying a scoring formula for scoring candidate MEC UAVs associated to candidate routes, generating an ordered list of qualifying mobile MEC UAVs based on application of the scoring formula, and orchestrator 110 selecting the highest ranked mobile MEC UAV from the ordered list.

Orchestrator 110 running route evaluating process 113 can include orchestrator 110 establishing and evaluating plurality of candidate routes for travel of a mobile MEC UAV from a base location to and from at least one IoT computer device.

Orchestrator 110 running session initiating process 114 can include orchestrator 110 deploying a mobile MEC UAV of mobile MEC UAVs 140A-140Z for initiating an IoT data uploading and processing session. Orchestrator 110 running session initiating process 114 can include orchestrator 110, in some use cases, provisioning a MEC UAV to perform processing of IoT sensor data associated to a particular IoT edge computer environment. Provisioning of a particular mobile MEC UAV can include installing, e.g., libraries and executable code for performance of a particular data processing application and/or function associated to a certain IoT edge computer environment of IoT edge computer environments 120A-120Z. Provisioning data can be prestored in provisioning area 2127 of data repository 108.

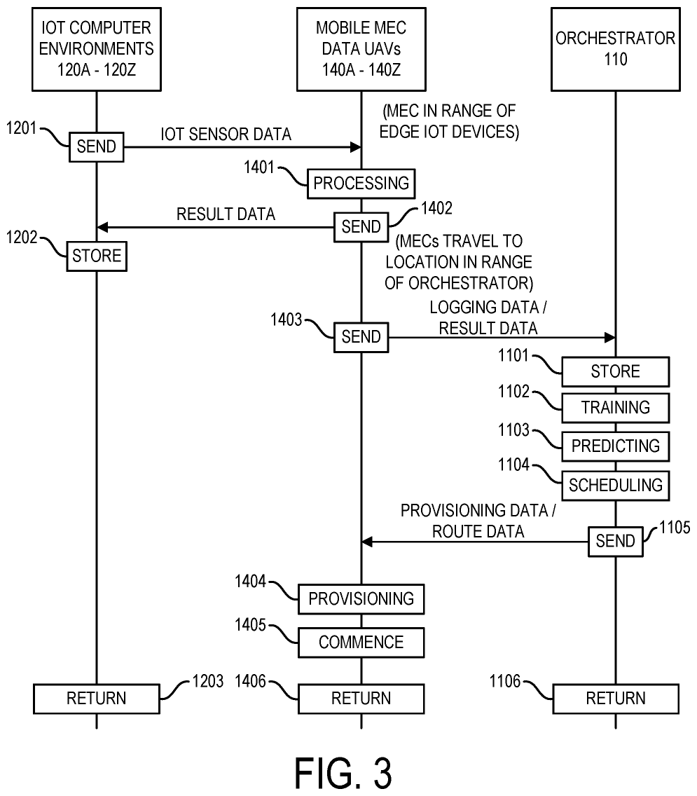

A method performance of mobile MEC UAVs 140A-140Z interoperating with IoT edge computer environments 120A-120Z and with orchestrator 110 is described with reference to the flowchart of FIG. 3. At block 1201 with mobile MEC UAVs 140A-140Z in connection range of one or more IoT edge computer environments 120A-120Z, IoT edge computer environments 120A to 120Z can be sending and uploading IoT sensor data for processing by mobile MEC UAVs 140A-140Z. Each respective IoT edge computer environment 120A-120Z can be configured to tag IoT sensor data sent to block 1201 with metadata tags that specify an identifier for the source IoT edge computer environment sending the IoT sensor data and timestamp specifying the time of the sending.

In response to the receipt of the IoT sensor data, mobile MEC UAVs 140A-140Z can perform processing of received IoT sensor data at processing block 1401. Processing block 1401 can include, e.g., processing unstructured IoT sensor data to produce structured IoT sensor data and/or processing to produce logging data. In one aspect, the structured data can feature reduced size relative to the unstructured IoT sensor data. The uploading depicted at block 1201 can be asynchronous or synchronous. The uploading depicted at block 1201 can include each of the respective IoT edge computer environments uploading IoT sensor data to a single one mobile MEC UAV to which it has been mapped.

At processing block 1401, mobile MEC UAVs 140A-140Z can perform processing to produce result data and can also or alternatively perform processing to produce logging data. Logging data as set forth herein can include logging data that specifies computing resource consumption by a mobile MEC UAV for processing of IoT sensor data received from a certain one IoT edge computer environment to which it is currently connected.

In response to the processing of IoT sensor data at block 1401, mobile MEC UAVs 140A-140Z can proceed to send block 1402. At send block 1402, mobile MEC UAVs 140A-140Z can send result data to IoT edge computer environments 120A-120Z. The result data can include the described structured IoT sensor data herein produced by the processing at processing block 1401. In response to the receipt of the result data received by the sending at block 1402, IoT edge computer environments 120A-120Z at store block 1202 can store the received result data. With this storage of result data at block 1202, IoT edge computer environments 120A-120Z in some use cases can purge some or all existing unstructured IoT sensor data stored in storage devices thereon. Embodiments herein recognize that IoT edge computer environments 120A-120Z in some use cases can have limited storage capacity and limited data processing capacity. Thus, offloading processing for data reduction can reduce the hardware and/or software provisioning requirements associated to the various IoT edge computer environments 120A-120Z.

Subsequent to the sending of result data at block 1402, mobile MEC UAVs 140A-140Z can autonomously fly to a base location in connection range of orchestrator 110. In one embodiment, the base location in connection range of orchestrator 110 can be the location of recharging station 182 (FIG. 2) so that MEC UAVs 140A-140Z can be recharged to full battery capacity while communicating data to and/or from orchestrator 110. The travel of mobile MEC UAVs to and from the base location can be synchronous or asynchronous. Referring to FIGS. 1 and 2, mobile MEC UAVs 140A-140Z can fly to a base location in connection range of base station 180 for access to network 190 and orchestrator 110. On connecting to orchestrator 110 via base station 180, mobile MEC UAVs 140A-140Z can upload at send block 1403 logging data and/or result data to orchestrator 110, and orchestrator 110 at store block 1101 can responsively store the logging data and/or result data into logging data area 2122 and/or results area 2121. The result data, as explained with reference to block 1401 can include structured IoT sensor data structured by use of the processing at block 1401.

On receipt of the described logging data, orchestrator 110 at training block 1102 can perform training of machine learning predictive model trained for predicting computing resource consumption of one or more IoT edge computer environment.

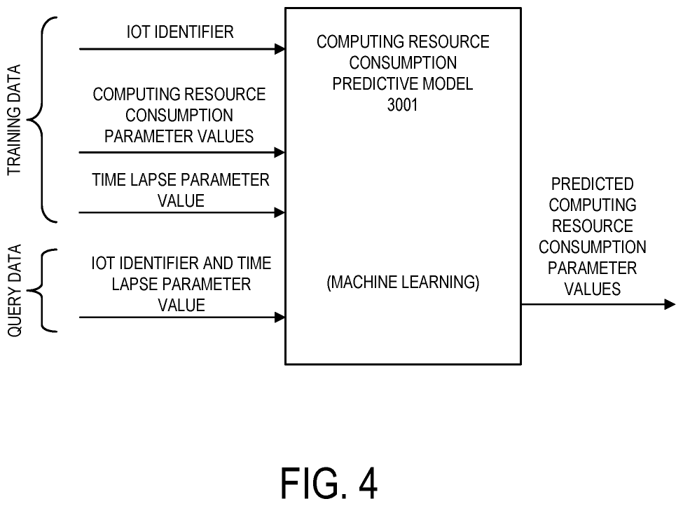

Training of a predictive model for predicting computing resource consumption is illustrated in reference to FIG. 4. Referring to FIG. 4, FIG. 4 illustrates computing resource consumption predictive model 3001 which can be trained with use of training data provided by logging data that can be produced at processing block 1401 and which can be uploaded to orchestrator 110 at block 1403.

On completion of training of computing resource consumption predictive model 3001. computing resource consumption predictive model 3001 can be configured to perform predictions as to computing resource consumption of a respective IoT edge computer environment. Computing resource consumption predictive model 3001 can be trained with iterations of training data and on completion of training can be configured to perform predictions. Iterations of training data for training computing resource consumption predictive model 3001 can include (a) an IoT identifier specifying a specific IoT edge computer environment that produced computing resource consumption parameter values during a data uploading and processing session, (b) computing resource consumption parameter values that are determined by the described logging agent associated to a mobile MEC UAV during a certain data uploading and data processing session in which data is processed by a mobile MEC UAV, and (c) a time-lapse parameter value that specifies a time-lapse from the certain data uploading and processing session to the most recent prior data uploading and processing session associated to the specific IoT edge computer environment. Embodiments herein recognize that a computing resource consumption load imposed by a particular IoT edge computer environment can be dependent on a time since a last data uploading, which can reflect a size of IoT sensor data and other characteristics of IoT sensor data to be uploaded.

The described iteration of training data can be applied to predictive model 3001 for each data upload and processing session performed by a mobile MEC UAV in association with a particular IoT edge computer environment. Computing resource consumption predictive model 3001, once trained, can be configured to perform predictions as to computing resource consumption of a particular IoT edge computer environment. Computing resource consumption predictive model 3001, once trained, can respond to query data for returning and providing the data value specifying predicted computing resource consumption parameter values associated to an IoT edge computer environment. Query data for querying computing resource consumption predictive model 3001 can include an IoT identifier specifying the IoT edge computer environment for which a prediction is requested and time-lapse parameter value specifying a time lapse between a next candidate data uploading and processing time and time of completion of the last data uploading and processing session for that particular IoT edge computer environment. Queried with the described query, data computing resource consumption predictive model 3001 can return a set of parameter values specifying predicted computing resource consumption of the particular IoT edge computer environment for which predicted consumption performance has been requested.

Training at block 1102 can include application of an iteration of training data as set forth herein. On completion of training at training block 1102, orchestrator 110 can proceed to predicting block 1103. Orchestrator 110 at predicting block 1103 can perform predicting as to the computing resource consumption of each IoT edge computer environment 120A to 120Z during the next data uploading and processing session. For performance of such predicting, orchestrator 110 can query predictive model 3001 with the described IoT identifier and time lapse parameter values described in reference to FIG. 4. In response, computing resource consumption predictive model 3001 can output predicted computing resource consumption parameter value specifying computing resource consumption of the various IoT edge computer environments 120A-120Z. In one use case scenario, multiple sets of predicted computing resource consumption parameter values can be generated for a certain IoT edge computer environment. For example, multiple sets of query data can be applied to computing resource consumption predictive model 3001, e.g., multiple sets of query data can be differentiated in terms of different time-lapse parameter values that correspond to different time-lapse scenarios corresponding to different possible data uploading and processing session initiate times. Embodiments herein recognize that next data uploading for next data uploading and processing session for a particular IoT edge computer environment can prospectively commence at varying different possible times depending on an ensuing scheduling.

Various available tools, libraries, and/or services can be utilized for implementation of predictive model 3001. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring, and retraining deployed models. Enabled REST APIs can provide e.g., retrieval of metadata for a given predictive model, deployment of models and management of deployed models, online deployment, scoring, batch deployment, stream deployment, monitoring, and retraining deployed models. Predictive model 3001 can employ, e.g., support vector machines (SVM), Bayesian networks, neural networks, and/or other machine learning technologies.

On completion of predicting at predicting block 1103, orchestrator 110 can proceed to scheduling block 1104. At scheduling block 1104, orchestrator 110 can schedule a data uploading and processing session between at least one mobile MEC UAV, at least one IoT edge computer environment, and one or more IoT edge computer environment.

At scheduling block 1104, orchestrator 110 can select a particular mobile MEC UAV for performing the data uploading and processing session for a particular IT edge computer environment based on one or more criterion being satisfied. The one or more criterion can include, e.g., computing resource matching criterion, a range matching criterion, a prioritization matching criterion and/or a function matching criterion.

At scheduling block 1104, orchestrator 110 can perform mapping between one or more MEC UAV and at least one IoT edge computer environment.

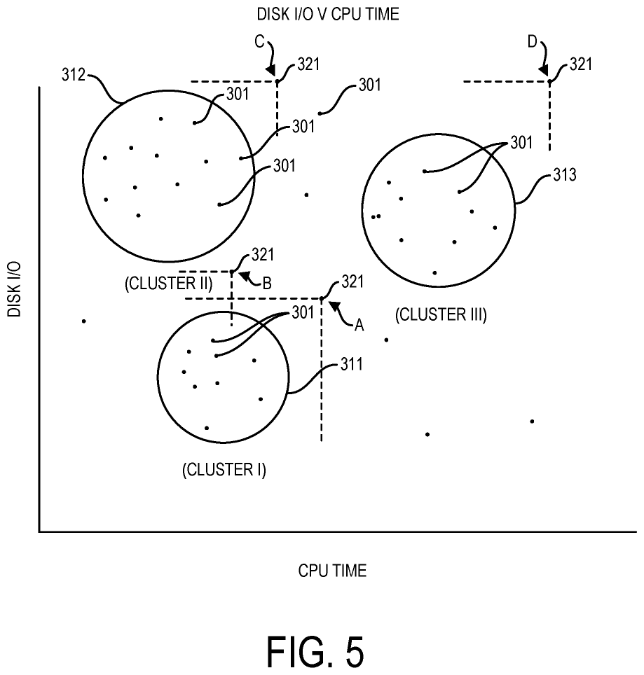

Regarding the computing resource matching criterion, orchestrator 110 can perform matching using clustering analysis as set forth in reference to the clustering analysis diagram of FIG. 5. The data points 301 can be produced by query of predictive model 3001. FIG. 5 depicts predicted computing resource consumption for IoT edge computer environments 120A-120Z under various time-lapse scenarios wherein computing resource consumption is expressed in terms of first and second dimensions. The first and second dimensions in the illustrative example of FIG. 5 can include CPU time (e.g., user time) consumption and a number of storage memory disk I/O operations. While clustering analysis and predicted resource consumption predictions are described in reference to first and second dimensions, the analysis and the predictions can be scaled to N dimensions. Dimensions subject to clustering analysis can include, e.g., CPU consumption data such as CPU user time (e.g., in ms and or number of cycles), CPU system time, CPU interrupt time, CPU wait time, memory consumption data such as, e.g., number of working memory I/O operations, number of storage memory I/O operations, working memory storage space utilized, storage memory storage space utilized, network consumption data such as throughput parameter values expressed, e.g., in terms of bits per second (BPS), response time parameter values, latency parameter values, and packet loss (error rate) parameter values.

Orchestrator 110 can group the dimensional data points into clusters, e.g., cluster I indicated by reference element 311, cluster II depicted by reference element 312, and cluster III depicted by reference element 313. In one scenario, orchestrator 110 can also plot on the clustering diagram of FIG. 5 performance attributes in multiple dimensions of various candidate mobile MEC UAVs. In the clustering diagram of FIG. 5, performance attributes in terms of computing resource capacity for various mobile MEC data platforms for the plotted CPU capacity and disk I/O capacity dimensions are specified with data points 321. Computing resource capacities for plotting against computing resource consumptions parameter values can be determined in dependence, e.g., text processing of hardware documentation, analysis of logging data, and/or input from experts.

At scheduling block 1104, orchestrator 110 can specify that a mobile MEC UAV capacity matches a predicted consumption level for an IoT edge computer environment where horizontal and vertical axes intersecting a mobile MEC UAV computing resource capacity data point 321 encompasses the cluster associated to a given IoT edge computer environment. For example, the mobile MEC UAV referenced with data point 321 at A encompasses, supports, and matches IoT edge computer environments of cluster I but not cluster II or III. The mobile MEC UAV referenced with data point 321 at B does not encompass, support, or match any IoT edge computer environments of any of cluster I, II, or III. The mobile MEC UAV referenced with data point 321 at C encompasses, supports, and matches IoT edge computer environments of cluster II but not cluster I (vertical axis intersects cluster I) or III. The mobile MEC UAV referenced with data point 321 at D encompasses, supports, and matches IoT edge computer environments of clusters I, II, and III.

Regarding the range criterion, the range criterion, in one example can be regarded to be satisfied where the mobile MEC UAV is able to travel from a base location in connection range of base station 180 to a connection range location associated to an IoT edge computer environment hover at the environment for the required amount of time to perform data uploading and processing and return to the base location in connection range of base station 180 within a timing imposed by the constraint of the battery life of mobile MEC UAV. For predicting battery life, a mobile MEC UAV can query a predictive model trained by machine learning. Query data for querying such predictive model can include candidate flight times, hover times, movement times, and associated speed times associated to the movement times.

Regarding the prioritization criterion, embodiments herein recognize that IoT edge computer environments can include associated prioritization levels in accordance with data uploading and processing intervals required for the various IoT edge computer environments, e.g., prioritization level 1 for data uploading and processing within 10 hours, prioritization level 2 for processing and upweighting within 100 hours, prioritization level 3 for processing and uploading required within 1000 hours, etc. In one embodiment, one or more IoT edge computer environments can be configured to include dynamic prioritization levels. In one example, an IoT edge computer environment can be configured to report increasing prioritization levels in dependence on the time lapse between the current time and the time of the last data uploading and processing session of the IoT edge computer environment.

Orchestrator 110 applying a prioritization criterion can match a mobile MEC UAV to a particular IoT edge computer environment where the mobile MEC UAV is able based on battery life and flight duration able to perform and service a data uploading and processing session.

Regarding the function criterion, orchestrator 110 can match a particular mobile MEC UAV to a certain IoT edge computer environment based on the mobile MEC UAV having a function or being capable of being upgraded to perform the function required by the particular IoT edge computer environment. In one example, there can be a requirement for certain data security associated to an IoT edge computer environment and various mobile MEC UAVs may or may not be capable of satisfying such security requirements.

In one use case scenario, orchestrator 110 can be configured to perform matching of a certain mobile MEC UAV to a particular IoT edge computer environment on a first in first out (FIFO) basis. That is, an IoT edge computer environment can be evaluated for matching, a mobile MEC UAV can be matched to the IoT edge computer environment and then deployed immediately upon qualification and matching of the mobile MEC UAV to the IoT edge computer environment without evaluation of alternative matching conditions between mobile MEC UAVs and IoT edge computer environments.

In another scenario, a plurality of IoT edge computer environments and a plurality of mobile MEC UAVs can be evaluated contemporaneously for identification of a plurality of matchings between mobile MEC UAVs and respectively mapped IoT edge computer environments.

In one use case scenario, orchestrator 110 can use a scoring formula as set forth in Eq. 1 for identification of mappings between one or more mobile MEC UAV and at least one IoT edge computer environment.

$$S = F 1 W 1 + F 2 W 2 + F 3 W 3 + F 4 W 4 \qquad ( Eq . 1 )$$

In Eq. 1, the described criterion referenced above in relation to computing resource matching, range matching, prioritization matching, and function matching can be expressed as factors. The scoring formula of Eq. 1 can be used to rank candidate mobile MEC UAVs for servicing a particular IoT edge computer environment. In another use case, orchestrator 110 can employ a scoring formula of Eq. 1 for ranking simultaneously mobile MEC UAV associations to a plurality of IoT edge computer environments. The set of matches producing the lowest cumulative score can be selected as the scheduling solution. In use of Eq. 1, orchestrator 110 can express each candidate mobile MEC UAV multiple times in evaluating candidate solutions.

Referring to Eq. 1. F1, F2, F3 and F4 can be factors used in evaluating candidate solutions expressed by the formula and W1 through W4 can be weights associated to the various factors. According to one embodiment, factor F1 can be a computing resource matching factor, F2 can be a range factor, F3 can be a prioritization factor, and F4 can be a function factor. These factors correspond to the criterion referenced above.

Referring to factor F1, orchestrator 110 can scale scoring values under factor F1 in dependence on the degree to which a certain mobile MEC UAV is matched to an IoT edge computer environment in terms of computing resource capacity and predicted consumption. In referring to FIG. 5, a mobile MEC UAV referenced at C and the mobile MEC UAV referenced at D both have the capacity to accommodate the predicted consumption of an IoT edge computer environment reference to within cluster II, and thus both are matched to IoT edge computer environments referenced within cluster II. However, with reference to the scoring formula of Eq. 1, the mobile MEC UAV referenced at C can be regarded to be better matched to a computer environment of cluster 2 based on having a shorter distance to cluster 2 than the depicted MEC UAV capacity data point at D. MEC UAV capacity datapoint to IoT edge computer environment distances can be determined in dependence on the Euclidean distance from a MEC UAV capacity data point to a centroid of an IoT edge computer environment cluster. Embodiments herein recognize that certain matching conditions can result in wasted overall resources, such as where a mobile MEC UAV mapped to a certain IoT edge computer environment has significantly greater computing resource capacity than required for servicing the certain IoT edge computer environment. Accordingly, a solution featuring the mobile MEC UAV referenced at C can be scored higher using Eq. 1 than the mobile MEC UAV referenced at D according to factor F1 of Eq. 1.

Orchestrator 110 applying scoring values under F2 can scale scoring values under factor F2 in dependence on efficiency in which battery life is used. For example, a mobile MEC UAV can be regarded to match under factor F2 where battery life permits performance of a deployment and servicing of a mobile MEC UAV in a particular IoT edge computer environment. However, orchestrator 110 can scale assigned scoring values relatively higher where a route involves making increased use of available battery life without recharging, wherein recharging can consume cost. Therefore, qualifying and matching candidate routes (that are able to service all targeted IoT edge computer environments referenced by the route) under factor F2 that consume a greater portion of available battery life can be scored higher under factor F2 by orchestrator 110 than candidate routes that consume a relatively smaller percentage of available battery life.

Therefore, it can be seen under factor F2 that orchestrator 110 can scale candidate routes encompassing visits to multiple IoT edge computer environments to relatively higher scoring values than candidate routes where a visit to only a single IoT edge computer environment is specified. Scoring values can be scaled under factor F2 and close to or at a maximum where the candidate route being evaluated consumes nearly all available battery life to support the candidate route.

As a precondition to matching a mobile MEC UAV to an IoT edge computer environment, orchestrator 110 can identify one or more candidate routes associated to the mobile MEC UAV, and can evaluate the mobile MEC UAV under Eq. 1 for each of the candidate routes. For identifying candidate routes associated to a mobile MEC UAV, orchestrator 110 can coarsely classify solutions to determine whether a mobile MEC UAV is capable of servicing more than one IoT edge computer environment using baseline distance and battery life data and thresholding. Where orchestrator 110 ascertains using coarse classification that a certain mobile MEC UAV can service a second (or third, or Nth) computer environment, orchestrator 110 can be qualified to generate multiple candidate routes involving the mobile MEC UAV and multiple IoT edge computer environments and can express the multiple different routes as candidate solutions for evaluation under Eq. 2.

For example, with reference to FIG. 1, the route from a base location in connection range of base station 180 to IoT edge computer environment 120A then to IoT edge computer environment 120C and then back to the base location in connection range of base station 180 can be regarded as a first route and the route from the base location in connection range of base station 180 to IoT edge computer environment 120C to IoT edge computer environment 120A and back to the base location in connection range of base station 180 can be regarded as a second route for evaluation.

In constructing candidate routes for a mobile MEC UAV servicing a certain IoT edge computer environment, orchestrator 110 can qualify IoT edge computer environments as being candidates to be grouped together and commonly serviced in a common route by a common mobile MEC UAV. The described qualifying IoT edge computer environments to be commonly serviced by a common mobile MEC UAV in a common router can include use of clustering analysis by orchestrator 110 for identification of similar IoT edge computer environments. Orchestrator 110, in one embodiment, can filter out and disqualify IoT edge computer environments from being serviced in a common route in response to a determination that the IoT edge computer environments have been classified as belonging to different clusters. Referring to FIG. 5, orchestrator 110, in one aspect, can determine that first and second IoT edge computer environments have associated respective data points 321 commonly classified in a common cluster (e.g., cluster I) and accordingly can qualify the first and second IoT edge computer environments for being prospectively serviced by a common mobile MEC UAV with a common single route. Referring to FIG. 5, orchestrator 110, in one aspect, can determine that first and third IoT edge computer environments have associated respective data points 321 classified in first and second different clusters (e.g., one in cluster I, one in cluster II) and accordingly can disqualify and filter out the first and third IoT edge computer environments for being prospectively serviced by a common mobile MEC UAV with a common single route. The first and second computing resource consumption dimensions in the illustrative example of FIG. 5 can include CPU time (e.g., user time) consumption and number of storage memory disk I/O operations. While clustering analysis and predicted resource consumption predictions are described in reference to first and second dimensions, the analysis and the predictions can be scaled to N dimensions. Dimensions subject to clustering analysis can include computer resource consumption data as described herein, e.g., CPU consumption data such as CPU user time (e.g., in ms and or number of cycles). CPU system time. CPU interrupt time, CPU wait time, memory consumption data such as, e.g., number of working memory I/O operations, number of storage memory I/O operations, working memory storage space utilized, storage memory storage space utilized, network consumption data such as throughput parameter values expressed, e.g., in terms of bits per second (BPS), response time parameter values, latency parameter values, and packet loss (error rate) parameter values. Dimensions subject to clustering analysis for ascertaining IoT edge computer environments that can be paired together for servicing by a mobile MEC UAV in a common route can be differentiated from dimensions subjecting to clustering analysis for purposes of assigning scoring values under factor F1. In one example, dimensions subject to clustering analysis for assigning scoring values under factor F1 can be restricted to computing resource consumption parameter values as set forth herein. Dimensions subject to clustering analysis for ascertaining similar IoT edge computer environment that can be serviced by a common route can also include, in addition, sensor data parameter values as set forth herein. Camera images by orchestrator 110 and or respective mobile MEC UAV's can be subject to camera image processing for pattern recognition and identified pattern sets associated an IoT edge computer environment can be expressed as parameter values. In one embodiment, a mobile MEC UAV can include another type of environment sensor, e.g., a temperature sensor, humidity sensor, and/or acoustic sensor and can be active to temperature, humidity, and/or sound data parameter values of IoT edge computer environments that are visited.

Orchestrator 110 applying scoring values under factor F3 can scale scoring values in dependence on the degree to which the candidate route matches a data collection prioritization associated to a particular IoT edge computer environment. As set forth herein, the various IoT edge computer environments 120A-120Z can have associated data uploading and processing prioritization levels, e.g., level 1 every 10 hours, level 2 every 100 hours, level 3 every 1.000 hours and so on.

Under factor F3, a candidate route resulting in expected data uploading and processing within 90 hours can be scored higher than an alternative candidate route with an expected data uploading and processing within 10 hours where a particular IoT edge computer environment being evaluated has a prioritization rating of 100 hours. Scoring values under factor F3 can be scaled to maximum or near maximum values where data collection uploading and processing is performed close to but not exceeding the specified prioritization rating associated to a particular IoT edge computer environment.

Orchestrator 110 applying scoring values under factor F4 can scale scoring values in dependence on the degree to which a function associated to a mobile MEC UAV being evaluated matches a required function associated to a particular IoT edge computer environment. Orchestrator 110 in some use cases matching under factor F4 can be binary, i.e., matching or not matching. In other use case scenarios, different functional capabilities of a mobile MEC UAV can be deemed qualifying in respect to requirements associated to a particular IoT edge computer environment. In one use case example, as set forth in the decision data structure of Table A, different IoT edge computer environments can be assigned different levels of security, e.g., security level 1 high security, security level 2 medium security, security level 3 baseline security, and different security functions can be determined to be in satisfaction of the different security requirements.

In the decision data structure of Table A, RAID 6 to RAID 1 storage can be regarded to be qualifying of and matching to the security level 1 and all RAID levels of storage can be determined to be qualifying of the security level 3, for example. For applying scoring values under factor F4, orchestrator 110 can use the decision data structure of Table A, according to one example.

TABLE A

| | Security | | |
|---|---|---|---|
| | requirement of IoT | | |
| | edge computer | Mobile MEC | Assigned scoring |
| | environment being | UAV storage | value under factor |
| Row | evaluated | security | F4 |
| 1 | 1 | RAID 6 | 1.0 |
| 2 | 1 | RAID 5 | 0.8 |
| 3 | 1 | RAID 4 | 0.6 |
| 4 | 1 | RAID 3 | 0.4 |
| 5 | 1 | RAID 2 | 0.2 |
| 6 | 1 | RAID 1 | 0.1 |
| 7 | 1 | RAID 0 | −99.0 |
| . . . | . . . | . . . | . . . |
| 15 | 3 | RAID 6 | 0.1 |
| . . . | . . . | .. . . | . . . |
| 20 | 3 | RAID 1 | 1.0 |
| 21 | 3 | RAID 0 | 0.8 |

Orchestrator 110 when evaluating matching to a security level 1 security requirement can assign descending scoring values to MEC UAV RAID storage levels, RAID 6 to RAID 1, and can disqualify a MEC UAV having RAID 0 storage (assigning a score of −99.0). Orchestrator 110 when evaluating matching to a security level 3 security requirement can assign differentiating qualifying scoring values to all MEC UAV RAID storage levels, and can assign a lower scoring value to a MEC UAV having RAID 6 than a MEC UAV having RAID 1 storage (RAID 6 may be regarded to be over-provisioning of storage security to the level 3 (lowest) storage requirement of the IoT edge computer environment being evaluated.

Referring to the decision data structure of Table B, orchestrator 110 can assign scoring values under factor F4 in dependence on whether the function is currently available on the mobile MEC UAV being evaluated or alternatively available upgrading software on the mobile MEC UAV.

TABLE B

| | Function | | |
|---|---|---|---|
| | requirement of IoT | | Assigned scoring |
| | edge computer | | value under factor |
| Row | environment | Mobile MEC UAV | F4 |
| 1 | Function F required | Currently | 1.0 |
| | | provisioned with | |
| | | Function F | |
| 2 | Function F required | Mobile MEC UAV | 0.8 |
| | | can be provisioned | |
| | | with Function F | |
| | | with single stage | |
| | | installation | |
| 3 | Function F required | Mobile MEC UAV | 0.6 |
| | | can be provisioned | |
| | | with Function F | |
| | | with single stage | |
| | | installation | |
| 4 | Function F required | Mobile MEC UAV | −99.0 |
| | | cannot be | |
| | | provisioned with | |
| | | Function F | |

Referring to the decision data structure of Table B, orchestrator 110 can assign a highest scoring value under factor F4 to an arbitrary function where the function is currently available, can assign a second highest scoring value, e.g., 0.8 where the function can be provisioned on a mobile MEC UAV with a single stage installation, and can assign the third highest scoring value, e.g. 0.6 where the mobile MEC UAV can be provisioned to include the function but with a multistage installation. Orchestrator 110 can disqualify a mobile MEC UAV where the mobile MEC UAV cannot be reprovisioned to include the arbitrary function.

Therefore, orchestrator 110 can scale scoring under factor F4 in dependence on the difficulty associated to a provisioning of a mobile MEC UAV.

As noted herein, orchestrator 110 at scheduling block 1104 can use Eq. 1 to evaluate multiple possible routes of a mobile MEC UAV in association with a target IoT edge computer environment or can contemporaneously evaluate multiple IoT edge computer environments with respect to routes associated to a plurality of different mobile MEC UAVs. In the scenario where matching to a single IoT edge computer environment is being evaluated, various routes can be ranked and orchestrator 110 can provide a selection based on the highest-ranking route. In the latter scenario where matching to a plurality of different IoT edge computer environments is being evaluated, orchestrator 110 can evaluate all possible permutations of qualifying candidate routes and can select a set of matches based on the set of matches that produces the highest cumulative score using instances of Eq. 1. The set of matches can provide a mapping between one or more mobile MEC UAV and at least one IoT edge computer environment.

With further reference to Eq. 1, Eq. 1 can be configured so that the failure of a match under any given factor can produce a negative score of an arbitrarily high value, as shown in Table A and B, that negates candidate route altogether. Various solutions are possible.

In one scenario, with reference to FIG. 1, orchestrator 110 can produce a mapping and scheduling whereby mobile MEC UAV 140A services IoT edge computer environment 120B with a single IoT edge computer environment visit route, mobile MEC UAV 140Z services IoT edge computer environment 120Z with a single IoT edge computer environment route, and mobile MEC UAV 140B successively services IoT edge computer environment 120C and IoT edge computer environment 120A in a multiple IoT edge computer environment route. In such a scenario, IoT edge computer environment 120C can have a higher data uploading and processing prioritization than IoT edge computer environment 120A, thus driving the visiting of IoT edge computer environment 120C before IoT edge computer environment 120A by operation of prioritization factor F3 of Eq. 1.

With scheduling completed at block 1104, orchestrator 110 can proceed to send block 1105. At send block 1105, orchestrator 110 can send provisioning data and/or route data to appropriate ones of mobile MEC UAVs 140A-140Z. Orchestrator 110 can send provisioning data at block 1105, e.g., where a mobile MEC UAV is not currently provisioned to perform data uploading and processing with respect to the data uploading and processing requirements of a particular IoT edge computer environment and/or where a particular mobile MEC UAV currently lacks a required function associated to a certain IoT edge computer environment. Provisioning data can include, e.g., libraries and executable code which when installed configures a mobile MEC UAV to perform a required data processing application or a required function as described in connection with factor F4 and the function criterion herein.

Mobile MEC UAVs 140A-140Z, on receipt of provisioning data sent at block 1105, can perform provisioning at block 1404. Provisioning at block 1404 can include installing an installation package having the described libraries and executable code for provisioning a mobile MEC UAV.

On completion of provisioning block 1404, mobile MEC UAVs 140A-140Z can proceed to block 1405. At block 1405, mobile MEC UAVs 140A-140Z, appropriately provisioned and programmed with appropriately selected route data can commence travel to an appropriate destination referenced in the route data sent at block 1105. The sending of provisioning data and/or route data at block 1105 can define deploying of a mobile MEC UAV to initiate a data uploading and processing in which IoT sensor data of a particular IoT edge computer environment is processed for return of result data.

At return block 1406, mobile MEC UAVs 140A-140Z can return to stage preceding processing block 1401 in order to wait for IoT sensor data to be received from a mapped IoT edge computer environment for processing appropriately when a mobile MEC UAV arrives in connection range of a targeted IoT edge computer environment of IoT edge computer environments 120A to 120Z.

Referring to blocks 1401 to 1406, it is seen that mobile MEC UAVs 140A-140Z can iteratively perform a loop wherein the mobile MEC UAVs 140A-140Z iteratively travel between a base location in connection range of base station 180 and locations in connection range of one or more IoT edge computer environment.

At the location of an IoT edge computer environment, a mobile MEC UAV can receive and process IoT sensor data in order to produce a result data and/or can produce logging data and when in connection range of an orchestrator 110 can upload logging data and/or result data to the orchestrator 110. The orchestrator 110 in response can train predictive models, query retrained predictive models to produce optimized scheduling for next round of deployments of mobile MEC UAVs. On completion of send block 1105, orchestrator 110 can proceed to return block 1106. At return block 1106 orchestrator 110 can return to a stage preceding store block 1101 and training block 1102 in order to receive a next iteration of logging data and/or result data. Orchestrator 110 can iteratively perform the loop of blocks 1101 to 1106 during a deployment period of system 100 and can be iteratively be performing multiple instances of the blocks 1101 to 1106 simultaneously and concurrently.

On completion of store block 1202 IoT edge computer environments 120A to 120Z can proceed to return block 1203. At return block 1203 IoT edge computer environments 120A-120Z can return to a stage preceding block 1201 to send a next iteration of IoT sensor data to a mobile MEC UAVs 140A-140Z. IoT edge computer environments 120A-120Z can be iteratively performing the loop of blocks 1201 to 1203 during a deployment period of system 100. Mobile MEC UAVs 140A-140Z can iteratively be performing the loop of blocks 1401 to 1406 during a deployment period of mobile MEC UAVs 140A-140Z. Orchestrator 110 can iteratively be performing the loop of blocks 1101 to 1105 during a deployment period of orchestrator 110.

As depicted in the flowchart of FIG. 3, there is set forth herein a computer implemented method comprising: examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of orchestrator 110 and first to Nth IoT edge computer environment locations, the first to Nth IoT edge computer environment locations being associated respectively to different IoT edge computer environments: mapping, in dependence on the examining, respective ones of the plurality of mobile multi-access computing unmanned aerial vehicles to at least one of the IoT edge computer environments: scheduling, according to the mapping, data upload and processing sessions in which the respective ones of the multi-access computing unmanned aerial vehicle receive and process IoT sensor data from an IoT edge computer environment of the first to Nth IoT edge computer environment locations; and deploying the respective ones of the plurality of mobile multi-access computing unmanned aerial vehicles for performance of the data upload and processing sessions.

Embodiments herein relate to unmanned aerial vehicle (UAV)-enabled edge computing (EC). Embodiments herein can provide a system and method to intelligently map UAV-MEC to target locations where edge devices are installed. Embodiments herein recognize that IoT devices generally have very limited or even no computation capability, because of which it is difficult for these devices to process and store the collected data. Embodiments herein recognize that edge computing brings the computation resource closer to user equipment and has the potential to help IoT devices by processing the data collected by them. However, in some areas such as farms, deserts, and rescue operation environments, it may not be possible to install conventional edge servers. Embodiments herein recognize that in such cases unmanned aerial vehicles (UAVs) integrated with the edge computing can be used. UAVs can be configured to fly closer to the IoT devices and process the data that is generated by them. In some cases, results are passed back to IoT devices and in other cases results can be passed to an orchestrator 110.

Embodiments herein can provide multiple edge servers with various configurations available at a base station. Such edge servers can be fixed to respective UAVs and can be deployed to a field. With a UAV affixed the edge servers can define mobile MEC UAVs. Embodiments herein recognize that if the data generated by IoT devices is negligible then resources of a mobile MEC UAV can be under-utilized. Embodiments herein recognize that if an under-provisioned mobile MEC UAV is deployed to field where huge amount of data is generated by IoT devices, the mobile MEC UAV will not be able to process all the data that is generated by edge devices because of its limited configuration. Embodiments herein recognize that in case of limited edge server configuration, a mobile MEC UAV might have to perform multiple trips to base station to offload the data collected from IoT.

Embodiments herein recognize that energy required by a mobile MEC UAV to hover over the field can be directly proportional to the time taken by the mobile MEC UAV to process the data. More the time to process, the more battery life is needed by drone to hover over the field. Hence, embodiments herein recognize that it can be beneficial to deploy mobile MEC UAV with the right configuration to the right target location in dependence on an examination of expected hovering time.

Embodiments herein can provide a system and method to intelligently map mobile MEC UAVs to target locations. Embodiments herein can provide orchestrator 110 co-located with a centralized server disposed, e.g., within a wireless network having a base station, a core network, and/or a data network.

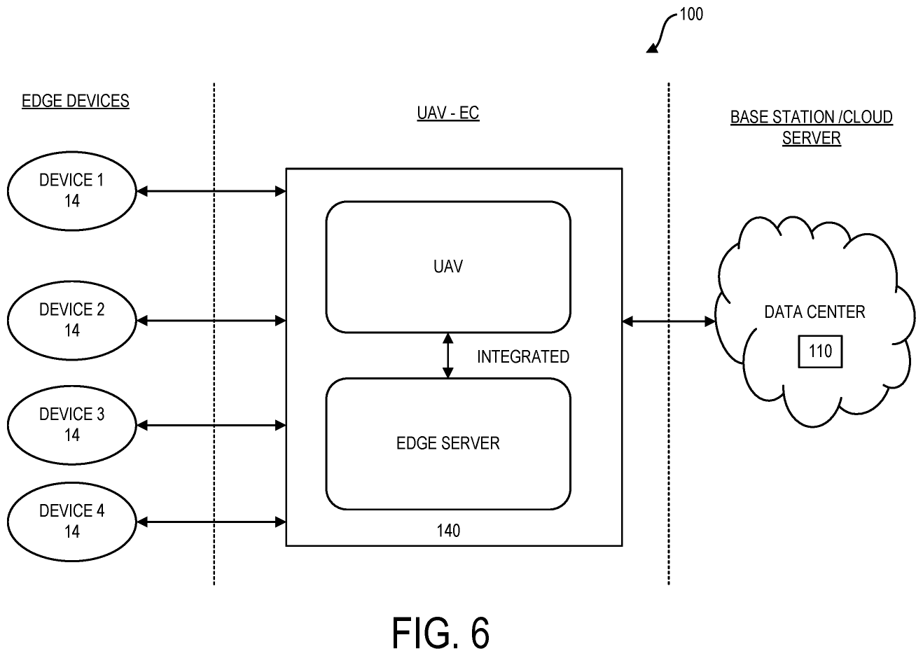

As indicated in FIG. 6, an embodiment of system 100 can include orchestrator 110 which can be located, e.g., in a centralized data center in communication with a mobile MEC UAV 140. Mobile MEC UAV 140 can be configured to be autonomously flyable between a base location in connection range of orchestrator 110, and respective connection range locations of respective IoT devices 14. In one embodiment, the respective IoT devices 14 can be disposed in respective spaced apart IoT edge computer environments as set forth herein.

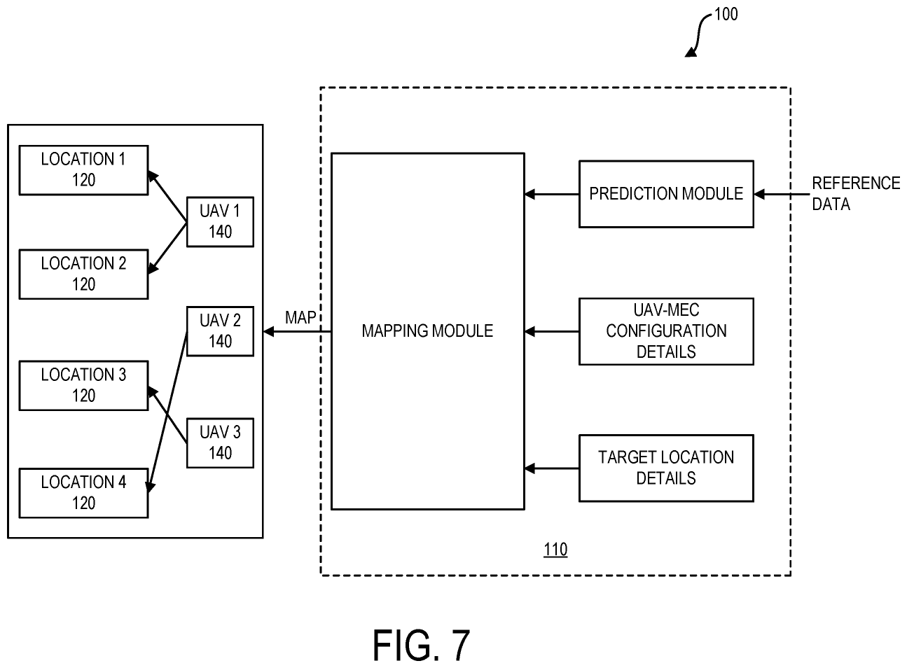

An orchestrator 110 of system 100 as shown in FIG. 7 can include a prediction module and a mapping module. The prediction module can be provided as a machine learning module that predicts the future computing resource consumption loads of edge devices. The mapping module can produce mappings between multiple mobile MEC UAVs 140 as set forth herein, and different IoT edge computer environments 120, which can be defined at spaced apart different geospatial regions.

In one embodiment there can be provided different categories of load forecasting, namely short-term load forecasting (STLF, ranging from a few hours to a few days), medium-term load forecasting (MTLF, several days up to a few months), and long-term load forecasting (LTLF, greater than or equal to one year).

Once computing resource consumption load is predicted for a given future time, orchestrator 110 can determine the computing capacity that is required to process the predicted load. For a given time and location, the prediction module can provide the computation capacity required to process the data.

In one embodiment, orchestrator 110 can employ cluster analysis model in determining computing capacity. Orchestrator 110 can gather data for each and every process and then categorize into a handful of groups. For example, one group may characterize processes which consume on average 500 KB of RAM, five seconds of CPU time per minute, and read/write 750 KB of data from/to the I/O subsystem. Once the processes are grouped into their respective categories, simulation or queuing theory models can provide a high confidence result.

To perform cluster analysis in an acceptable time frame, queuing theory and data gathering processes (process clusterization) can be developed.

With further reference to orchestrator 110, the illustrated mapping module can takes parameter values as inputs and provide mapping between mobile MEC UAVs and target location. The parameter values can include, e.g., an output of the prediction module such as the predicted computing resource consumption and computing capacity required for each target location for given time. The parameter values can include, e.g., sensor details, computing capacity, RAM, storage, battery level, etc. of each mobile MEC UAV. The parameter values can include, e.g., co-ordinates, security flags, type of data, priority etc. of each target location/edge devices.

Orchestrator 110 can process the datasets for the below given scenarios, according to one example: (1) If security parameter is enabled [S (ed) n=true] on an edge device/target location then there would be one on one mapping between UAV with required computation capacity and target location. (2) If there are multiple target location which have similarity in data and also mobile MEC UAVs have sufficient computation capacity and no security is enabled then one UAV to many target location mapping can be performed. A K-means algorithm can be used for this clustering model. Orchestrator 110 employing K-means can determine what the common characteristics are for individual IoT edge computer environments and can group them together. (3) Orchestrator 110 can use the output of the clustering from (2) and priority data to determine which IoT edge computer environment is to be mapped with a particular UAV. (4) If (2) is negated and there is no similarity in data then assign 1:1 mapping based on required computation capacity. (5) In case that a mobile MEC UAV is unavailable, the above data can re-calculated with available mobile MEC UAVs. (6) For a given edge device location, if the priority is low and all mobile MEC UAVs are engaged, then this edge device will be moved to awaited state. Orchestrator 110 can then provide a final mapping between mobile MEC UAVs and IoT edge computer environments.

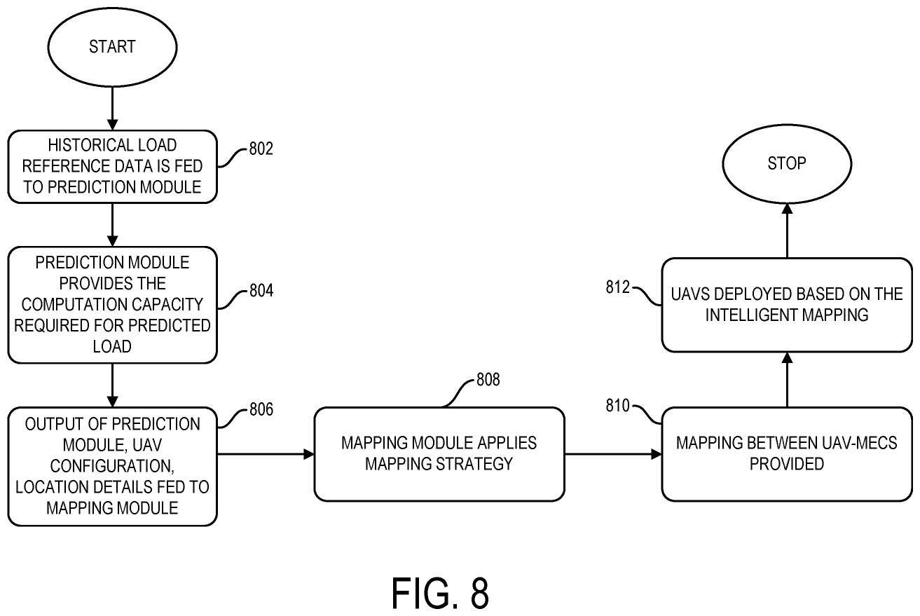

As set forth in reference to FIG. 8, orchestrator 110 can obtain at block 802 historical load reference data. At block 804 a prediction module of orchestrator 110 can provide a prediction as to computation capacity required for a predicted load. At block 806, an output of the prediction module, and a mobile MEC UAV configuration, and target location details can be fed into a mapping module. At block 808, the mapping module can apply a mapping strategy. At block 810 orchestrator 110 can provide mapping between mobile MEC UAVs and target IoT edge computer environments. At block 812 orchestrator can deploy mobile MEC UAVs for initiating data upload and processing sessions in which IoT sensor data of IoT edge computer environments is uploaded for processing by respective mobile MEC UAVs.

Certain embodiments herein may offer various technical computing advantages involving computing advantages and practical applications to address problems arising in the realm of computer systems and computer networks. Embodiments herein address a problem with the “last mile” of computer system connectivity, and can intelligently provide with conserved resources connectivity to remote areas out of connectivity range to centralized system. Embodiments herein can intelligently map capabilities of a mobile MEC UAV to an IoT edge computer environment so that resources, including computing resources, are conserved and not underutilized or overutilized. Embodiments herein can include intelligent mapping of capabilities of mobile MEC UAVs to IoT edge computer environments so that resources, including computing resources of mobile MEC UAVs, are not underutilized and not overutilized. Embodiments herein can avoid and provide technical solutions for conductivity where an IoT edge computer environment is out of range of the centralized orchestrator, e.g., an orchestrator disposed in a core network or a data network. Embodiments herein can employ use of logging data collected by processing of IoT sensor data and using the logging data to train predictive models. Such predictive models once trained can be used to return and provide predictions as to computing resources consumption of IoT edge computer environments. An orchestrator in turn can use the described predictions to perform intelligent scheduling of one or more MEC UAV with respect to one or more IoT edge computer environment. Various decision data structures can be used to drive artificial intelligence (AI) decision making, such as decision data structures for use in assigning scoring values to MEC UAVs being evaluated for matching to an IoT edge computer environment. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as IoT sensor devices associated to spaced apart and differentiated IoT edge computer environments. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

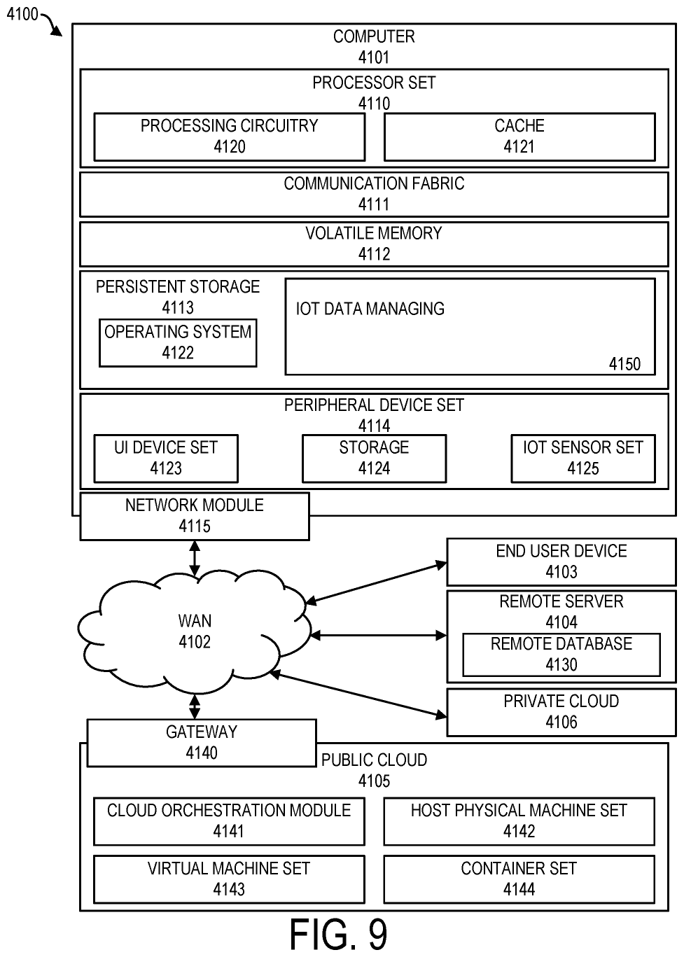

In reference to FIG. 9 there is set forth a description of a computing environment 4100 that can include one or more computer 4101. In one example, computing node 10 as set forth herein can be provided in accordance with computer 4101 as set forth in FIG. 9.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 9. In one aspect, a computing environment 4100 contains an example of an environment for the execution of at least some of the computer code involved in performing the inventive methods, such as code 4150 for managing IoT data as set forth in reference to FIGS. 1-8. Code for managing IoT data can include, e.g., code for scheduling mobile MEC UAVs, code for provisioning MEC UAVs, code for uploading data, e.g., IoT sensor data, results data, and/or logging data, code for processing data. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk. C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a.” “an.” and “the” are intended to include the plural forms as well, unless the context clearly indicates otherwise. It will be further understood that the terms “comprise” (and any form of comprise, such as “comprises” and “comprising”). “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments:
scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments; and
deploying the mobile multi-access computing unmanned aerial vehicle for performance of the data upload and processing session.

2. The computer implemented method of claim 1, wherein the logging data comprises computing resource consumption data.

3. The computer implemented method of claim 1, wherein the examining includes querying a predictive model that has been trained with training data, the training data provided by the logging data.

4. The computer implemented method of claim 1, wherein the logging data comprises computing resource consumption data, and wherein the examining includes querying a predictive model that has been trained with training data, the training data provided by the logging data.

5. The computer implemented method of claim 1, wherein the scheduling includes mapping, in dependence on the examining, the mobile multi-access computing unmanned aerial vehicles to at least one IoT edge computer environment of the set of IoT edge computer environments.

6. The computer implemented method of claim 1, wherein the scheduling includes mapping, in dependence on the examining, the mobile multi-access computing unmanned aerial vehicle to at least one IoT edge computer environment of the set of IoT edge computer environments, wherein the logging data comprises computing resource consumption data.

7. The computer implemented method of claim 1, wherein the examining includes querying a predictive model to provide predictions respecting computing resource consumption of IoT edge computer environments of the set of IoT edge computer environments, wherein the predictive model has been trained using data of the logging data, and wherein the logging data comprises computing resource consumption data, and wherein the scheduling is in dependence on a result of the querying the predictive model to provide the predictions respecting computing resource consumption of the IoT edge computer environments of the set of IoT edge computer environments.

8. The computer implemented method of claim 1, wherein the examining includes predicting, with use of data of the logging data, computing resource consumption of a plurality of IoT edge computer environments of the set of IoT edge computer environments, and wherein the scheduling is performed in dependence on a matching of a computing resource capacity of the mobile multi-access computing unmanned aerial vehicle to a predicted computing resource consumption of the IoT edge computer environment of the set of IoT edge computer environments.

9. The computer implemented method of claim 1, wherein the examining includes predicting, with use of data of the logging data, computing resource consumption of IoT edge computer environments of the set of IoT edge computer environments, and wherein the scheduling is performed in dependence on an evaluation of multiple factors including a computing resource matching factor, wherein a computing resource capacity of the mobile multi-access computing unmanned aerial vehicle is matched to a prediction from the predicting of the computing resource consumption of the IoT edge computer environments of the set of IoT edge computer environments, and a range factor in which a battery capacity on the mobile multi-access computing unmanned aerial vehicle and a flight distance of the mobile multi-access computing unmanned aerial vehicle to the IoT edge computer environment are evaluated.

10. The computer implemented method of claim 1, wherein the examining includes predicting, with use of data of the logging data, computing resource consumption of a plurality of IoT edge computer environments of the set of IoT edge computer environments, and wherein the scheduling is performed in dependence on an evaluation of multiple factors including a computing resource matching factor, wherein a computing resource capacity of the mobile multi-access computing unmanned aerial vehicle is matched to a prediction from the predicting of the computing resource consumption of the IoT edge computer environments of the set of IoT edge computer environments, and a range factor in which a battery capacity on the mobile mobile multi-access computing unmanned aerial vehicle and a flight distance of the mobile multi-access computing unmanned aerial vehicle to the IoT edge computer environment are evaluated, wherein the deploying includes sending route data for receipt by the mobile multi-access computing unmanned aerial vehicle, the route data for controlling an aerial route followed by the mobile multi-access computing unmanned aerial vehicle in travelling between the base location and a location of the IoT edge computer environment.

11. The computer implemented method of claim 1, wherein the examining includes predicting, with use of data of the logging data, computing resource consumption of a plurality of IoT edge computer environments of the set of IoT edge computer environments, and wherein the scheduling is performed in dependence on an evaluation of multiple factors including a computing resource matching factor, wherein a computing resource capacity of the mobile multi-access computing unmanned aerial vehicle is matched to a prediction from the predicting of the computing resource consumption of the IoT edge computer environments of the set of IoT edge computer environments, and a range factor in which a battery capacity on the mobile multi-access computing unmanned aerial vehicle and a flight distance of the mobile multi-access computing unmanned aerial vehicle to the IoT edge computer environment are evaluated, wherein the deploying includes sending route data for receipt by the mobile multi-access computing unmanned aerial vehicle, and wherein the mobile multi-access computing unmanned aerial vehicle uses the route data in travelling between the base location and a location of the IoT edge computer environment.

12. The computer implemented method of claim 1, wherein the method includes determining, in dependence on performance of clustering analysis, that the IoT edge computer environment is classified in a common cluster with a certain IoT edge computer environment of the first through Nth computer environments, constructing, in dependence on the determining, a candidate route of the mobile multi-access computing unmanned aerial vehicle in which the mobile multi-access computing unmanned aerial vehicle visits the IoT edge computer environment and the certain IoT edge computer environment, and wherein the scheduling is performed in dependence on a first determination that a computing resource capacity of the mobile multi-access computing unmanned aerial vehicle is matched to a predicted computing resource consumption of the IoT edge computer environment and the certain IoT edge computer environment, and wherein the scheduling is also performed in dependence on a second determination that the mobile multi-access computing unmanned aerial vehicle has sufficient battery capacity to travel from the base location, visit both the IoT edge computer environment and the certain IoT edge computer environment, and return to the base location.

13. The computer implemented method of claim 1, wherein the method includes determining, in dependence on performance of clustering analysis, that the IoT edge computer environment is classified in a common cluster with a certain IoT edge computer environment of the first through Nth computer environments, constructing, in dependence on the determining, a candidate route of the mobile multi-access computing unmanned aerial vehicle in which the mobile multi-access computing unmanned aerial vehicle visits the IoT edge computer environment and the certain IoT edge computer environment, and wherein the scheduling is performed in dependence on a first determination that a computing resource capacity of the mobile multi-access computing unmanned aerial vehicle matched to a predicted computing resource consumption of the IoT edge computer environment and the certain IoT edge computer environment, and wherein the scheduling is also performed in dependence on a second determination that the mobile multi-access computing unmanned aerial vehicle has sufficient battery capacity to travel from the base location, visit both the IoT edge computer environment and the certain IoT edge computer environment, and return to the base location, wherein dimensions evaluating for the clustering analysis include computing resource consumption parameters, and sensor based parameters derived from camera image data representing environments of the first through Nth IoT edge computer environments.

14. The computer implemented method of claim 1, wherein the examining includes querying a predictive model to provide predictions respecting computing resource consumption of IoT edge computer environments of the set of IoT edge computer environments, wherein the predictive model has been trained using data of the logging data, and wherein the logging data comprises computing resource consumption data, and wherein the scheduling is in dependence on a result of the querying the predictive model to provide the predictions respecting the computing resource consumption of the IoT edge computer environments of the set of IoT edge computer environments, wherein the method includes determining, in dependence on performance of clustering analysis, that the IoT edge computer environment is classified in a common cluster with a certain IoT edge computer environment of the first through Nth computer environments, constructing, in dependence on the determining, a candidate route of the mobile multi-access computing unmanned aerial vehicle in which the mobile multi-access computing unmanned aerial vehicle visits the IoT edge computer environment and the certain IoT edge computer environment, and wherein the scheduling is performed in dependence on a first determination that a computing resource capacity of the mobile multi-access computing unmanned aerial vehicle is matched to a predicted computing resource consumption of the IoT edge computer environment and the certain IoT edge computer environment, and wherein the scheduling is also performed in dependence on a second determination that the mobile multi-access computing unmanned aerial vehicle has sufficient battery capacity to travel from the base location, visit both the IoT edge computer environment and the certain IoT edge computer environment, and return to the base location, wherein dimensions evaluating for the clustering analysis include computing resource consumption parameters, and sensor based parameters derived from camera image data representing environments of the first through Nth IoT edge computer environments.

15. The computer implemented method of claim 1, wherein the examining includes querying a predictive model to provide predictions respecting computing resource consumption of IoT edge computer environments of the set of IoT edge computer environments, wherein the predictive model has been trained using data of the logging data, and wherein the logging data comprises computing resource consumption data, and wherein the scheduling is in dependence on a result of the querying the predictive model to provide the predictions respecting computing resource consumption of the IoT edge computer environments of the set of IoT edge computer environments and in dependence on a matching of a computing resource capacity of the mobile multi-access computing unmanned aerial vehicle to a predicted computing resource consumption of the IoT edge computer environment, as determined from the querying the predictive model.

16. The computer implemented method of claim 1, wherein the examining includes querying a predictive model to provide predictions respecting computing resource consumption of IoT edge computer environments of the set of IoT edge computer environments, wherein the predictive model has been trained using data of the logging data, and wherein the logging data comprises computing resource consumption data, and wherein the scheduling is in dependence on a result of the querying the predictive model to provide the predictions respecting the computing resource consumption of the IoT edge computer environments of the set of IoT edge computer environments and in dependence on a matching of a computing resource capacity of the mobile multi-access computing unmanned aerial vehicle to a predicted computing resource consumption of the IoT edge computer environment, as determined from the querying the predictive model, wherein iterations of training data for training the predictive model include (i) a set of computing resource consumption parameter values for a data uploading and processing session: (ii) an identifier for a certain IoT computer environment associated to the session of (i), and (iii) a time lapse parameter value specifying a time lapse from a most recent data uploading and processing session of the IoT computer environment of (ii) so that the predictive model is trained to learn a relationship for respective IoT edge computer environments of the first through Nth IoT edge computer environments between computing resource consumption and a time lapse from a most recent data uploading and processing sessions for the respective IoT edge computer environments of the first through Nth IoT edge computer environments.

17. The computer implemented method of claim 1, wherein the plurality of mobile multi-access computing unmanned aerial vehicles include at least first and second mobile multi-access computing unmanned aerial vehicles, wherein the examining includes querying a predictive model to provide predictions respecting computing resource consumption of IoT edge computer environments of the set of IoT edge computer environments, wherein the predictive model has been trained using data of the logging data, and wherein the logging data comprises computing resource consumption data, and wherein the scheduling is in dependence on a result of the querying the predictive model to provide the predictions respecting the computing resource consumption of the IoT edge computer environments of the set of IoT edge computer environments and in dependence on a matching of a computing resource capacity of the mobile multi-access computing unmanned aerial vehicle to a predicted computing resource consumption of the IoT edge computer environment, as determined from the querying the predictive model, wherein iterations of training data for training the predictive model include (i) a set of computing resource consumption parameter values for a data uploading and processing session: (ii) an identifier for a certain IoT computer environment associated to the session of (i), and (iii) a time lapse parameter value specifying a time lapse from a most recent data uploading and processing session of the IoT computer environment of (ii) so that the predictive model is trained to learn a relationship for respective IoT edge computer environments of the first through Nth IoT edge computer environments between computing resource consumption and a time lapse from a most recent data uploading and processing sessions for the respective IoT edge computer environments of the first through Nth IoT edge computer environments, wherein the method includes determining, in dependence on performance of clustering analysis, that the IoT edge computer environment is classified in a common cluster with a certain IoT edge computer environment of the first through Nth computer environments, constructing, in dependence on the determining, a candidate route of the mobile multi-access computing unmanned aerial vehicle in which the mobile multi-access computing unmanned aerial vehicle visits the IoT edge computer environment and the certain IoT edge computer environment, and wherein the scheduling is performed in dependence on a first determination that a computing resource capacity of the mobile multi-access computing unmanned aerial vehicle is matched to a predicted computing resource consumption of the IoT edge computer environment and the certain IoT edge computer environment, and wherein the scheduling is also performed in dependence on a second determination that the mobile multi-access computing unmanned aerial vehicle has sufficient battery capacity to travel from the base location, visit both the IoT edge computer environment and the certain IoT edge computer environment, and return to the base location, wherein dimensions evaluating for the clustering analysis include computing resource consumption parameters, and sensor based parameters derived from camera image data representing environments of the first through Nth IoT edge computer environments, wherein the deploying includes sending route data for receipt by the mobile multi-access computing unmanned aerial vehicle, the route data for controlling an aerial route followed by the mobile multi-access computing unmanned aerial vehicle in travelling between the base location and a location of the IoT edge computer environment.

18. A system comprising:
a memory;
at least one processor in communication with the memory; and
program instructions executable by one or more processor via the memory to perform a method comprising:
examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments;
scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments; and
deploying the mobile multi-access computing unmanned aerial vehicle for performance of the data upload and processing session.

19. A computer program product comprising:
a computer readable storage medium readable by one or more processing circuit and storing instructions for execution by one or more processor for performing a method comprising:
examining, by an orchestrator, logging data received from a plurality of mobile multi-access computing unmanned aerial vehicles, wherein each mobile multi-access unmanned aerial vehicle of the plurality of mobile multi-access unmanned aerial vehicles is capable of being flown between a base location in connection range of the orchestrator and at least one computer environment location of a set of IoT computer environment locations, wherein respective computer environment locations of the set of computer environment locations are associated respectively to different IoT edge computer environments defining a set of IoT edge computer environments;
scheduling, in dependence on the examining, a data upload and processing session in which a mobile multi-access computing unmanned aerial vehicle of the plurality of mobile multi-access computing unmanned aerial vehicles receives and processes IoT sensor data from an IoT edge computer environment of the set of IoT edge computer environments; and
deploying the mobile multi-access computing unmanned aerial vehicle for performance of the data upload and processing session.
